(19) United States
(12) Patent Application Publication
(10) Pub. No.: US 2025/0080662 A1
(43) Pub. Date: Mar. 6, 2025

(54) IMAGE FORMING APPARATUS, METHOD FOR CONTROLLING THE SAME, AND STORAGE MEDIUM

(71) Applicant: CANON KABUSHIKI KAISHA, Tokyo (JP)

(72) Inventor: NOBUAKI FUKASAWA, Tokyo (JP)

(21) Appl. No.: 18/820,644

(22) Filed: Aug. 30, 2024

(30) Foreign Application Priority Data
Sep. 1, 2023 (JP) 2023-142380

(51) Int. Cl. H04N 1/00

(52) U.S. Cl. CPC H04N 1/00092; H04N 1/00037; H04N 1/00045; H04N 1/00074; H04N 1/0009; H04N 1/00724; H04N 1/00726

(57) ABSTRACT

The present image forming apparatus detects a characteristic of a sheet fed from a sheet feeding unit, prints a chart for detecting a parameter of the characteristic of the sheet on the sheet and register the parameter of the characteristic of the sheet on a basis of the chart together with the characteristic of the sheet, and performs control to continue the registering in a case where an absence of sheets is detected at the sheet feeding unit in the registering.

### BACKGROUND OF THE INVENTION

### Field of the Invention

The present invention relates to an image forming apparatus, a method for controlling the same, and a storage medium.

### Description of the Related Art

Japanese Patent Laid-Open No. 2002-029120 discloses an image forming apparatus including a function for registering a sheet type (hereinafter, user-set sheet) customized by a user in a database (hereinafter, sheet brand DB). This image forming apparatus includes a function for setting a sheet type which has been selected by a user from the sheet brand DB as the type of sheet fed to a feeder.

The quality of a printed image for the image forming apparatus depends largely on whether or not the characteristics of the image forming apparatus (conveying characteristics, transfer characteristics, fixing characteristics, and the like) are compatible with the characteristics of the sheet (sheet type, grammage, and the like). Japanese Patent Laid-Open No. 2020-12940 discloses an image forming apparatus that can associate various characteristic values of the image forming apparatus with each sheet type in advance and register these as sheet profiles.

Recent known image forming apparatuses include a function for detecting the characteristics (for example, grammage and the like) of a sheet by scanning the sheet and registering these as the characteristics of the sheet. In particular, when registering a sheet used for the first time, in order to set the characteristics of the sheet as parameters in the registration operation, a chart may be printed on the sheet, and the parameters may be obtained on the basis of the chart. Another function may be provided for reducing the load of the sheet registration task on the user by, in parallel with the chart printing, scanning the sheet used in this printing and presenting the results.

In a case where the sheet feeding unit that feeds a sheet to be registered is a manual feed tray, a sheet settings screen is displayed when a sheet is placed in the manual feed tray. Then, when the sheet leaves the manual feed tray, the settings screen for manual feeding sheet is closed. Thus, in a case where a sheet is fed from the manual feed tray, a chart is printed on the sheet, and the sheet type is registered, when chart printing is complete, there is a possibility that the remaining number of sheets in the manual feed tray is zero. In such a case, since the settings screen for manual feeding sheet is closed, the registration task is cancelled. This inconveniences the user as they have to open the settings screen for manual feeding sheet again and restart the registration task from the beginning.

### SUMMARY OF THE INVENTION

The present invention enables realization of a technique that, in a sheet registration process, can continue the registration process even when there is an absence of sheets in a sheet feeding unit.

One aspect of the present invention provides an image forming apparatus comprising: one or more memory devices that store a set of instructions; and one or more processors that execute the set of instructions to: detect a characteristic of a sheet fed from a sheet feeding unit, print a chart for detecting a parameter of the characteristic of the sheet on the sheet and register the parameter of the characteristic of the sheet on a basis of the chart together with the characteristic of the sheet, and perform control to continue the registering in a case where an absence of sheets is detected at the sheet feeding unit in the registering.

Another aspect of the present invention provides a method for controlling an image forming apparatus comprising: detecting a characteristic of a sheet fed from a sheet feeding unit; printing a chart for detecting a parameter of the characteristic of the sheet on the sheet and registering the parameter of the characteristic of the sheet on a basis of the chart together with the characteristic of the sheet; and performing control to continue the registering in a case where an absence of sheets is detected at the sheet feeding unit in the registering.

Still another aspect of the present invention provides a non-transitory computer-readable storage medium comprising instructions that, when executed by a computer system, cause the computer system to: detect a characteristic of a sheet fed from a sheet feeding unit; print a chart for detecting a parameter of the characteristic of the sheet on the sheet and register the parameter of the characteristic of the sheet on a basis of the chart together with the characteristic of the sheet; and perform control to continue the registering in a case where an absence of sheets is detected at the sheet feeding unit in the registering.

Further features of the present invention will be apparent from the following description of exemplary embodiments with reference to the attached drawings.

### BRIEF DESCRIPTION OF THE DRAWINGS

FIG. 1 is a block diagram for describing the hardware configuration of an image forming apparatus according to a first embodiment.

FIG. 2 is a diagram illustrating an example configuration of a network system according to the first embodiment.

FIG. 3 is a functional block diagram for describing the functions of the image forming apparatus according to the first embodiment.

FIG. 4 is a diagram for describing the transitions of screens displayed on an operation unit of the image forming apparatus according to the first embodiment.

FIG. 5 is a diagram for describing the transitions of screens displayed on an operation unit of the image forming apparatus according to a second embodiment.

FIG. 6 is a flowchart for describing the processing executed by the image forming apparatus according to the first embodiment when the state of the sheet in a manual feed tray changes.

FIG. 7 is a flowchart for describing the display control processing of a manual feeding sheet settings screen by the image forming apparatus according to the first embodiment.

FIG. 8 is a flowchart for describing the display control processing of a sheet type registration start screen by the image forming apparatus according to the first embodiment.

FIG. 9 is a flowchart for describing the display control processing of an adjustment 1 start screen by the image forming apparatus according to the first embodiment.

FIG. 10 is a flowchart for describing the display control processing of an adjustment 1 printing screen by the image forming apparatus according to the first embodiment.

FIG. 11 is a flowchart for describing the display control processing of an adjustment 1 settings screen by the image forming apparatus according to the first embodiment.

FIG. 12 is a flowchart for describing the display control processing of an adjustment 2 start screen by the image forming apparatus according to the first embodiment.

FIG. 13 is a flowchart for describing the display control processing of an adjustment 2 printing screen by the image forming apparatus according to the first embodiment.

FIG. 14 is a flowchart for describing the display control processing of an adjustment 2 settings screen by the image forming apparatus according to the first embodiment.

FIG. 15 is a flowchart for describing the display control processing of a sheet registration operation screen by the image forming apparatus according to the first embodiment.

FIG. 16 is a flowchart for describing the display control processing of the cancel screen by the image forming apparatus according to the first embodiment.

FIG. 17 is a flowchart for describing the display control processing of an adjustment 1 printing screen by the image forming apparatus according to the second embodiment.

FIG. 18 is a flowchart for describing the display control processing of an adjustment 2 printing screen by the image forming apparatus according to the second embodiment.

FIG. 19 is a flowchart for describing the display control processing of an absence of sheet error screen by the image forming apparatus according to the second embodiment.

### DESCRIPTION OF THE EMBODIMENTS

### First Embodiment

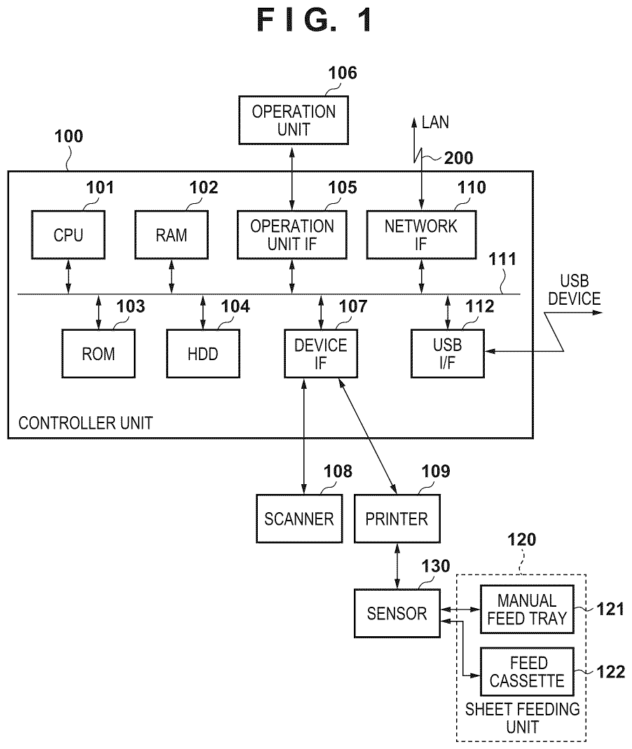

FIG. 1 is a block diagram for describing the hardware configuration of an image forming apparatus according to the first embodiment.

A controller unit 100 controls the image forming apparatus. A CPU 101 comprehensively controls each apparatus connected to a system bus 111 by executing a program in ROM 103 and/or a program loaded on RAM 102. The CPU 101, the RAM 102, the ROM 103, an HDD 104, an operation unit I/F 105, a device I/F 107, a network I/F 110, and a USB I/F 112 are connected to the system bus 111. The RAM 102 provides a system working memory for the CPU 101 to operate and also provides image memory for temporarily storing image data. Also, the RAM 102 includes a program loading area for an operating system, system software, application software, and the like and a data storing area. The ROM 103 stores a system boot program and the like. Also, the ROM 103 may store system programs and application programs and may store information required by the image forming apparatus such as fonts and the like. The HDD 104 is a hard disk drive and stores an operating system, system software, application software, document data, image data, settings data, and the like. A program loaded on the RAM 102 is executed by the CPU 101, and the CPU 101 processes image data and data other than images stored in the RAM 102, the ROM 103, and the HDD 104. Also, a small-sized image forming apparatus may have a hard-diskless configuration without the HDD 104 in which system software, application software, and the like is stored in the ROM 103. Alternatively, a configuration can naturally be used in which, instead of the HDD 104, a storage apparatus other than a hard disk, such as a solid state disk (SSD) or other flash memory, is used.

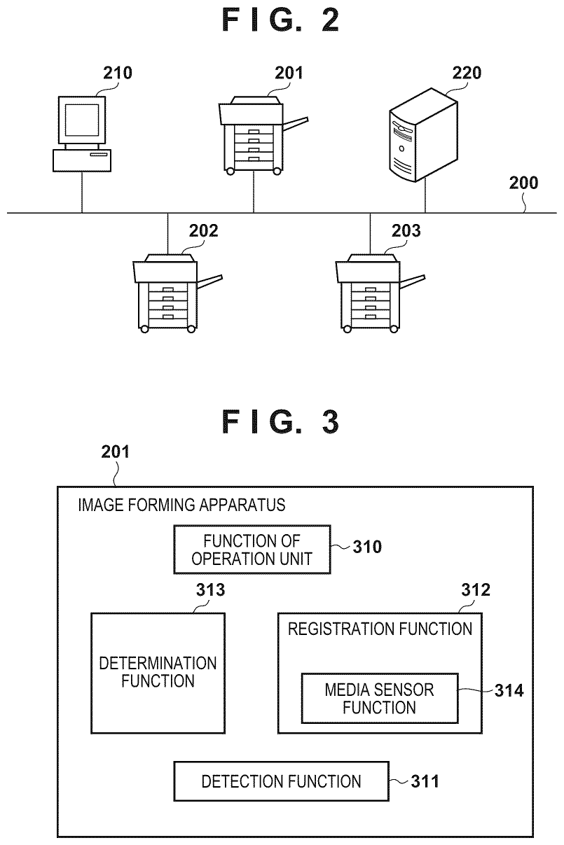

The operation unit I/F (interface) 105 is connected to an operation unit 106. The operation unit 106 includes a display unit such as a touch panel that notifies about the state of the image forming apparatus and receives operations from the user. The operation unit 106 is an apparatus for operating the image forming apparatus that includes an operation button and the like for issuing instructions to the image forming apparatus. The device I/F 107 connects a scanner 108 and a printer 109, which are image input/output devices, and the controller unit 100 and inputs and outputs image data. The image data input from the scanner 108 via the device I/F 107 is stored in the RAM 102 or the HDD 104. Image processing and the like is executed on the stored image data using an application program stored in the RAM 102 as necessary. Also, in a similar manner, when the image data is output, the image data is output to the printer 109 via the device I/F 107. The network I/F 110 is connected to a LAN 200 (FIG. 2) and inputs and outputs document data of an external device on the network, image data, information for controlling the image forming apparatus, or the like. The USB I/F 112 can connect with an external such as a USB device, and the CPU 101 can print by reading out data stored in the external memory. Also, the image data obtained by scanning via the scanner 108 can be stored in the connected external memory. A sheet feeding unit 120 is a device that stores sheets to be fed to the printer 109 and includes a manual feed tray 121 and a feed cassette 122. The manual feed tray 121 and the feed cassette 122 each include a sensor (not illustrated) that detects the presence/absence of loaded sheets. A sensor 130 is provided on the conveying path along which sheets are fed from the sheet feeding unit 120 and detects the type (sheet type) of the sheet by optically scanning the sheet fed from the sheet feeding unit 120.

Note that naturally, as long as the effect of the present invention is satisfied, the configuration is not limited to the configuration of FIG. 1 and a different configuration can be used. For example, in the case of an image forming apparatus with a fax function, the controller unit 100 may be provided with a non-illustrated modem apparatus I/F, connect to a public line via a modem, and transmit faxes.

Note that the processing executed by the image forming apparatus described below are all executed under the control of the CPU 101 that executes programs as described above.

FIG. 2 is a diagram illustrating an example configuration of a network system according to the first embodiment.

A PC 210, a PC 220, and image forming apparatuses 201, 202, and 203 are connected to the LAN 200. In the example described below, the image forming apparatus 201 and the PC 210 are used, but the following also applies to the image forming apparatuses 202 and 203 and the PC 220.

The image forming apparatus 201 corresponds to an image forming apparatus according to the first embodiment described using FIG. 1 and transmits and receives various types of data including print job data with the PC 210 via the LAN 200. Also, the image forming apparatus 201 includes a function (print function) for printing a received print job data with the printer 109 and a function (box function) for storing in the HDD 104. The image forming apparatus 201 also includes a function (copy function) for printing, with the printer 109, document data and image data obtained by scanning a document with the scanner 108, a function (box function) for storing in the HDD 104, and a function (send function) for transmitting to the PC 210. The image forming apparatus 201 also includes a function (network box function) for displaying a document stored in the storage area of the PC 210 on the operation unit 106 and printing using the printer 109.

FIG. 3 is a functional block diagram for describing the functions of the image forming apparatus 201 according to the first embodiment. These functions are executed by the CPU 101 of the image forming apparatus 201.

A function 310 of an operation unit corresponds to a function of the operation unit 106 shown in FIG. 1 and is used when the image forming apparatus 201 is externally operated. A detection function 311 is a function for detecting the status of the sheets in the manual feed tray 121. A registration function 312 is a function for registering new sheet types that registers, in the image forming apparatus 201, a sheet type created by an instruction from the operation unit 106 or a sheet type created by a media sensor function 314. The media sensor function 314 is a function for creating a new sheet type by the sensor 130 detecting the sheet fed from the sheet feeding unit 120. A determination function 313 determines whether to continue registration via the registration function 312.

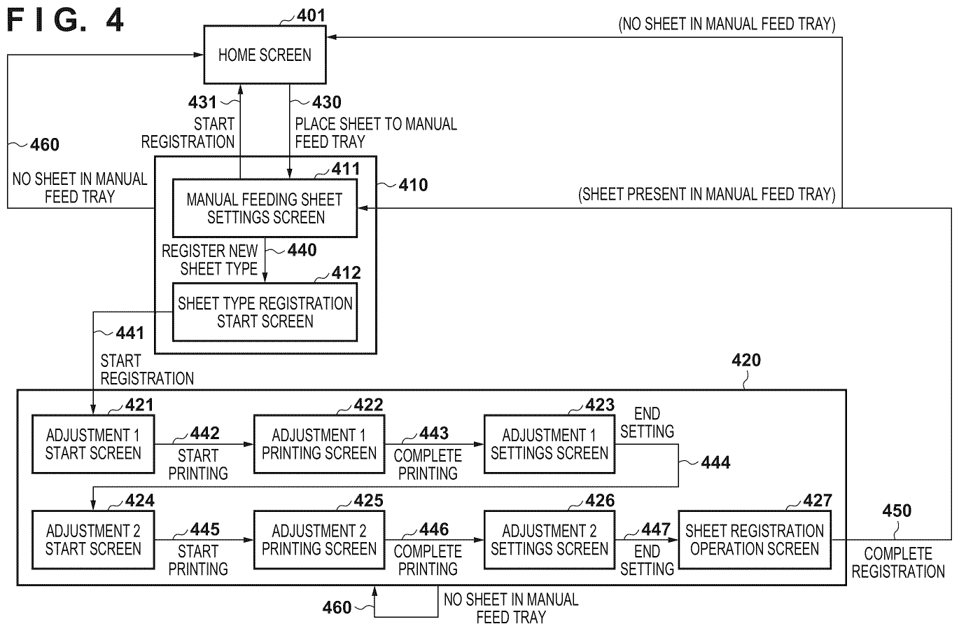

FIG. 4 is a diagram for describing the transitions of screens displayed on the operation unit 106 of the image forming apparatus 201 according to the first embodiment. In the example described below, these screens are operated via the operation unit 106.

A home screen 401 is the home screen of the image forming apparatus 201. A manual feeding sheet settings screen 411 is displayed upon an event 430 in which the detection function 311 detects a sheet set in the manual feed tray 121. Also, on the manual feeding sheet settings screen 411, in addition to setting the existing sheet type as the sheet of the manual feed tray 121, a new sheet type can be created and registered in the image forming apparatus 201 by the registration function 312 and set as the sheet of the manual feed tray 121. A sheet type registration start screen 412 is a screen that is displayed upon an instruction for registration of a new sheet type on the manual feeding sheet settings screen 411 (event 440) and is the starting point for creating a new sheet type. In creating a new sheet type, the characteristics of a sheet are set as parameters (hereinafter, adjustment parameters). Specific examples of adjustment parameters include grammage, color, and the like, and these indicate the characteristics of the sheet. FIG. 4 illustrates an example in which two adjustment parameters are set, but the number of adjustment parameters is not limited thereto. An example in which a printed product (chart) is printed on a sheet fed from the manual feed tray 121 and the adjustment parameters are set using the chart is illustrated in FIG. 4 as a screen flow. However, the method is not limited to a method of setting using a printed chart. The user may perform the setting via the operation unit 106 without using a chart.

When a registration start instruction is received from the operation unit 106 via the sheet type registration start screen 412 (event 441), an adjustment 1 start screen 421 is displayed. The adjustment 1 start screen 421 is a settings start screen for a first adjustment parameter (adjustment 1 in FIG. 4) to be set. When a print start instruction is received from the operation unit 106 via the adjustment 1 start screen 421 (event 442), the image forming apparatus 201 starts printing the chart described above and displays an adjustment 1 printing screen 422. Then, when printing of the chart is complete (event 443), an adjustment 1 settings screen 423 is displayed. On the adjustment 1 settings screen 423, an adjustment parameter is set on the basis of the printed chart for the new sheet type. Note that with a setting that doesn't use a chart, the adjustment 1 start screen 421 and the adjustment 1 printing screen 422 are not displayed, and the screen may transition from the event 441 to the adjustment 1 settings screen 423. In other words, the first embodiment is not affected by a difference in screen transitions due to a difference in the setting method.

When setting via the adjustment 1 settings screen 423 ends (event 444), an adjustment 2 start screen 424, which is a settings start screen for a second adjustment parameter, is displayed. In the example of FIG. 4, as with the first adjustment parameter, a chart is used for the second adjustment parameter. Event 445, event 446, an adjustment 2 printing screen 425, and an adjustment 2 settings screen 426 are similar to those for the first adjustment parameter and thus will not be described. When setting via the adjustment 2 settings screen 426 ends (event 447), a sheet registration operation screen 427 for registering a new sheet type with the image forming apparatus 201 is displayed. In this manner, when registration is complete (event 450), if there are sheets in the manual feed tray 121, the manual feeding sheet settings screen 411 is again displayed. On the other hand, if there is an absence of sheets in the manual feed tray 121, the home screen 401 is displayed. When an instruction is received to complete settings (event 431) via the manual feeding sheet settings screen 411, the home screen 401 is displayed.

Here, the time period during which the sheet type registration start screen 412 is displayed from the manual feeding sheet settings screen 411 corresponds to a phase 410. Also, the time period during which the sheet registration operation screen 427 is displayed from the adjustment 1 start screen 421 corresponds to a phase 420. In the phase 410, if an absence of sheets is detected at the manual feed tray 121 (event 460), the screen returns to the home screen 401. In the phase 420, even if an absence of sheets is detected at the manual feed tray 121 (event 460), the screen does not transition and the current screen is displayed.

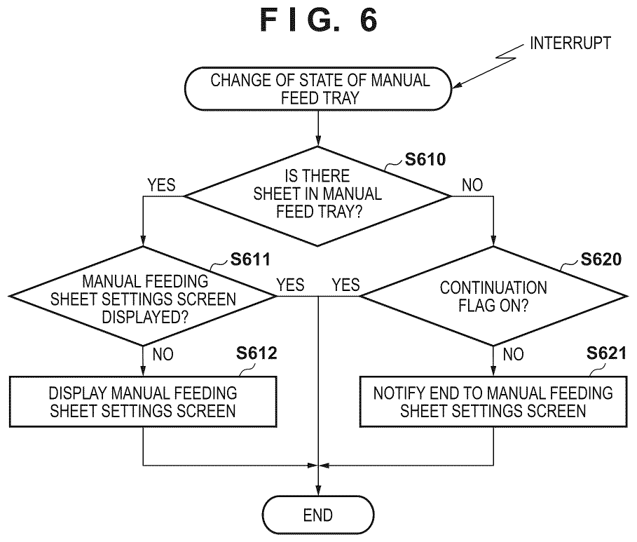

FIG. 6 is a flowchart for describing the processing executed by the image forming apparatus 201 according to the first embodiment when the state of the sheet in the manual feed tray 121 changes. The processing illustrated by the flowchart is executed by the CPU 101 executing a program loaded on the RAM 102 as described above.

The processing is started by an interrupt of the CPU 101, and first in step S610, the CPU 101 determines the presence/absence of a sheet in the manual feed tray 121. If it is determined that there is a sheet in the manual feed tray 121, the processing proceeds to step S611. If it is determined that there is an absence of sheets, the processing proceeds to step S620. In step S611, if the CPU 101 determines that display of the manual feeding sheet settings screen 411 on the operation unit 106 is complete or that the manual feeding sheet settings screen 411 exists beneath the display layer, the processing ends. On the other hand, if it is determined that the manual feeding sheet settings screen 411 has not been displayed or does not exist beneath the display layer, the processing proceeds to step S612, the manual feeding sheet settings screen 411 is displayed on the operation unit 106 (event 430), and the processing ends.

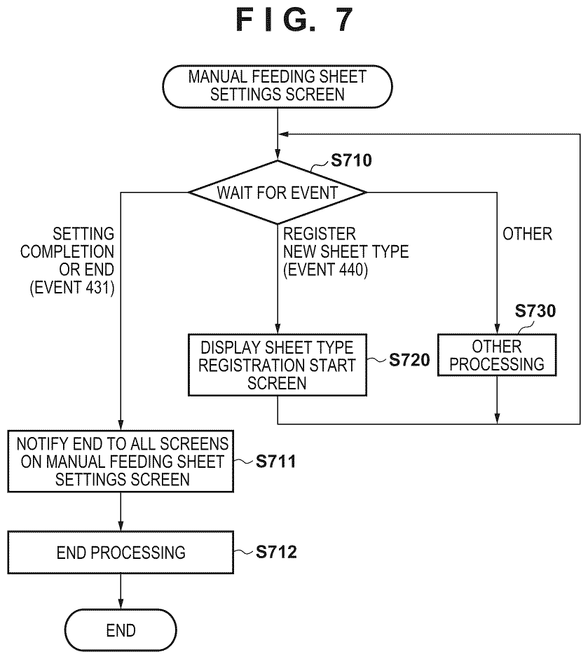

In step S620, the CPU 101 determines whether or not a continuation flag is on. If on, the processing ends, and if off, the processing proceeds to step S621. In step S621, the CPU 101 communicates the end of display of the manual feeding sheet settings screen 411. This notification is the event 460 of the phase 410 and corresponds to a case in which an end notification is received in step S710 of FIG. 7 described below. Note that the continuation flag is provided in the RAM 102 and is set to on when the sheet type registration start screen 412 for registering a new sheet type is displayed and registration processing is started and set to off when registration is completed via the sheet registration operation screen 427. In other words, the continuation flag is set to on while the registration processing is being executed.

According to the processing, the manual feeding sheet settings screen 411 is displayed when there are sheets in the manual feed tray 121 or alternatively when there is a change in state from there being an absence of sheets in the manual feed tray 121 to there being sheets in the manual feed tray 121. Also, even in the case of a state in which there is an absence of sheets in the manual feed tray 121, when a screen for registering the sheet type is being displayed, this screen will not be closed.

FIG. 7 is a flowchart for describing the display control processing of the manual feeding sheet settings screen 411 by the image forming apparatus 201 according to the first embodiment. The processing illustrated by the flowchart is executed by the CPU 101 executing the program described above.

In step S710, the CPU 101 is in a state of waiting for an event from the outside. Here, if there is a settings complete instruction (event 431) or an end notification, the processing proceeds to step S711. In step S711, the CPU 101 notifies all of the screens displaying the manual feeding sheet settings screen 411 as the starting point of the end. Thereafter, the processing proceeds to step S712, and the CPU 101 executes end processing of the manual feeding sheet settings screen 411 and ends the processing.

On the other hand, in step S710, if the CPU 101 determines that there is the new sheet type registration event 440, the processing proceeds to step S720, and the sheet type registration start screen 412 is displayed on the operation unit 106 and the processing returns to step S710. Also, in step S710, if the CPU 101 receives a different event, the processing proceeds to step S730, and the CPU 101 executes processing in accordance with the received event and the processing returns to step S710.

With this processing, when the new sheet type registration event 440 is received while the manual feeding sheet settings screen 411 is being displayed, the sheet type registration start screen 412 can be displayed on the operation unit 106.

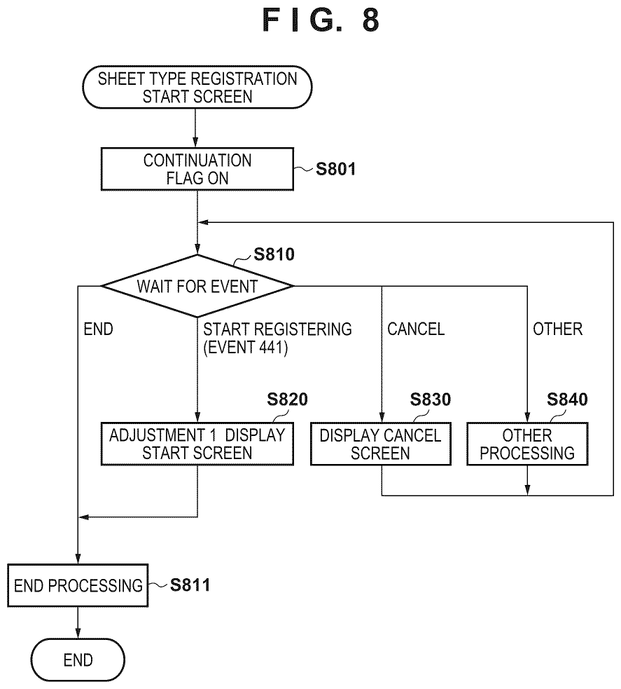

FIG. 8 is a flowchart for describing the display control processing of the sheet type registration start screen 412 by the image forming apparatus 201 according to the first embodiment. The processing illustrated by the flowchart is executed by the CPU 101 executing the program described above.

In step S801, the CPU 101 sets the continuation flag of the RAM 102 to on if the sheet type registration start screen 412 is displayed. Subsequently, the processing proceeds to step S810, and the CPU 101 waits for an event from the outside. In step S810, if the CPU 101 receives the event 441, the processing proceeds to step S820, the adjustment 1 start screen 421 is displayed on the operation unit 106, and the processing proceeds to step S811. On the other hand, in step S810, if there is a cancel instruction, the processing proceeds to step S830, and the CPU 101 displays a cancel screen (described below), and the processing returns to step S810. Also, in step S810, if a different event is received, the processing proceeds to step S840, and the CPU 101 executes processing in accordance with that event and the processing returns to step S810. Also, in step S810, if there is an end instruction, the processing proceeds to step S811, and the CPU 101 ends the sheet type registration start screen 412. This ends the processing.

With this processing, when a registration start event is received while the sheet type registration start screen 412 is being displayed, the adjustment 1 start screen 421 can be displayed on the operation unit 106 (transition to the phase 420).

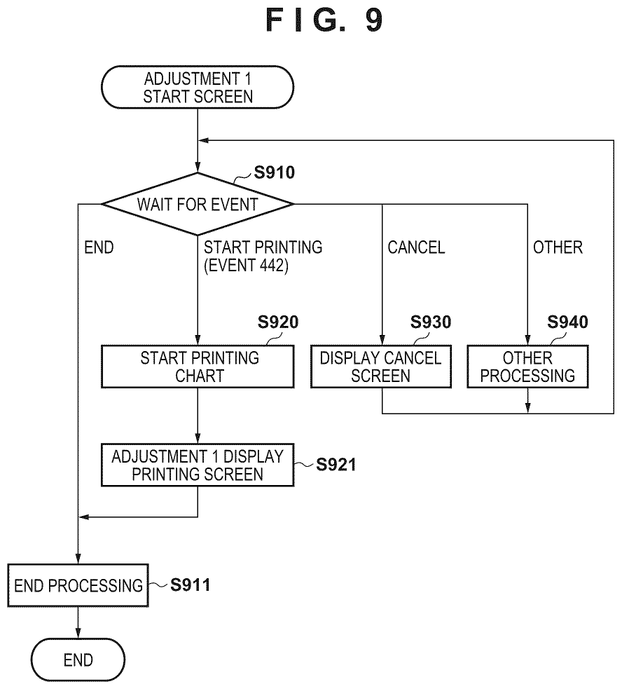

FIG. 9 is a flowchart for describing the display control processing of the adjustment 1 start screen 421 by the image forming apparatus 201 according to the first embodiment. The processing illustrated by the flowchart is executed by the CPU 101 executing the program described above.

In step S910, the CPU 101 waits for an event from the outside. Here, if the print start event 442 is received, the processing proceeds to step S920, and the CPU 101 starts the printing of the chart. Then, the processing proceeds to step S921, and the CPU 101 displays the adjustment 1 printing screen 422 indicating that the chart is being printed on the operation unit 106, and the processing proceeds to step S911. Also, in step S910, if there is a cancel instruction, the processing proceeds to step S930, and the CPU 101 displays a cancel screen, and the processing returns to step S910. Also, in step S910, if a different event is received, the processing proceeds to step S940, and the CPU 101 executes processing in accordance with the received event and the processing returns to step S910. Also, in step S910, if there is an end instruction, the processing proceeds to step S911, and the CPU 101 ends the adjustment 1 start screen 421, and the processing ends.

With this processing, when a print start event is received while the adjustment 1 start screen 421 is being displayed, printing of the chart using the adjustment 1 can be started.

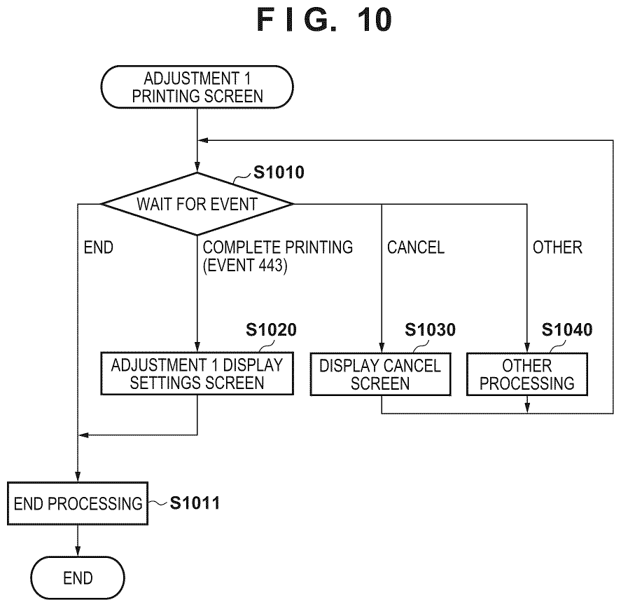

FIG. 10 is a flowchart for describing the display control processing of the adjustment 1 printing screen 422 by the image forming apparatus 201 according to the first embodiment. The processing illustrated by the flowchart is executed by the CPU 101 executing the program described above.

In step S1010, the CPU 101 waits for an event from the outside. Here, if the print complete event 443 is received, the processing proceeds to step S1020, and the CPU 101 displays the adjustment 1 settings screen 423 on the operation unit 106, and the processing proceeds to step S1011. Also, in step S1010, if there is a cancel instruction, the processing proceeds to step S1030, and the CPU 101 displays a cancel screen, and the processing returns to step S1010. Also, in step S1010, if a different event is received, the processing proceeds to step S1040, and the CPU 101 executes processing in accordance with that event and the processing returns to step S1010. Also, in step S1010, if there is an end instruction, the processing proceeds to step S1011, and the CPU 101 ends the adjustment 1 printing screen 422, and the processing ends.

With this processing, when printing ends while the adjustment 1 printing screen 422 is being displayed, the adjustment 1 settings screen can be displayed on the operation unit, and a screen for setting the adjustment 1 parameter can be transitioned to.

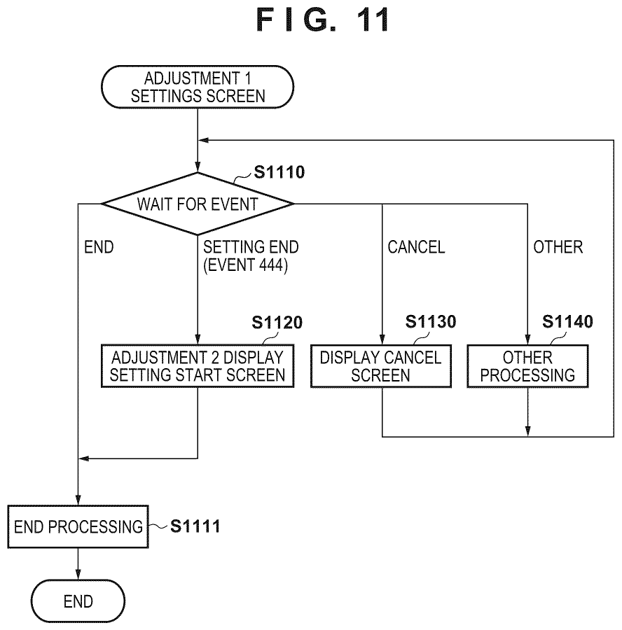

FIG. 11 is a flowchart for describing the display control processing of the adjustment 1 settings screen 423 by the image forming apparatus 201 according to the first embodiment. The processing illustrated by the flowchart is executed by the CPU 101 executing the program described above.

In step S1110, the CPU 101 waits for an event from the outside. Here, if the adjustment 1 setting complete event 444 is received, the processing proceeds to step S1120, and the CPU 101 displays the adjustment 2 start screen 424 on the operation unit 106, and the processing proceeds to step S1111. Also, in step S1110, if there is a cancel instruction, the processing proceeds to step S1130, and the CPU 101 displays a cancel screen, and the processing returns to step S1110. Also, in step S1110, if a different event is received, the processing proceeds to step S1140, and the CPU 101 executes processing in accordance with that event and the processing returns to step S1010. Also, in step S1110, if there is an end instruction, the processing proceeds to step S1111, and the CPU 101 ends the display of the adjustment 1 settings screen 423, and the processing ends.

With this processing, when setting ends while the adjustment 1 settings screen 423 is being displayed, the adjustment 2 start screen 424 for starting the processing for setting the next second adjustment parameter can be displayed on the operation unit.

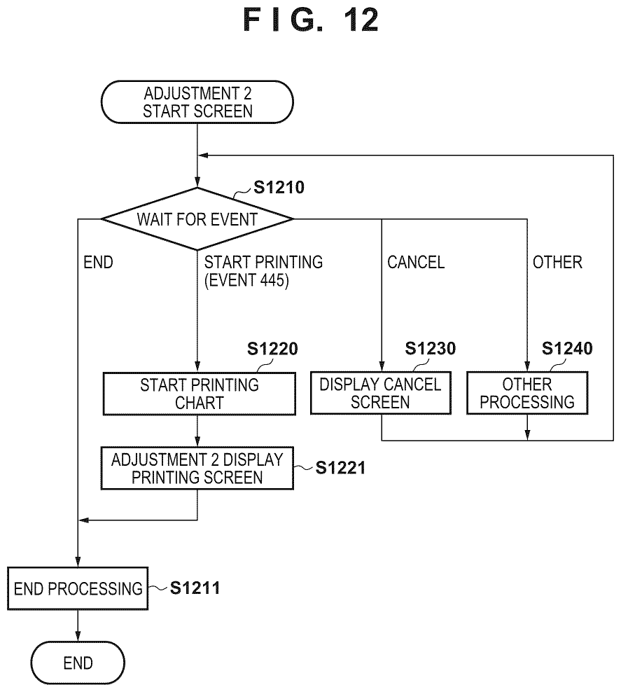

FIG. 12 is a flowchart for describing the display control processing of the adjustment 2 start screen 424 by the image forming apparatus 201 according to the first embodiment. The processing illustrated by the flowchart is executed by the CPU 101 executing the program described above.

In step S1210, the CPU 101 waits for an event from the outside. Here, if the print start event 445 is received, the processing proceeds to step S1220, and the CPU 101 starts the printing of the chart. Then, the processing proceeds to step S1221, and the CPU 101 displays the adjustment 2 printing screen 425 indicating that the chart is being printed on the operation unit 106, and the processing proceeds to step S1211. Note that steps S1230, S1240, and S1211, which are processing executed when, in step S1210, there is a cancel instruction or when another event is received and when there is an end instruction, are the same as steps S930, S940, and S911 of FIG. 9 and thus will not be described.

With this processing, when a print start event is received while the adjustment 2 start screen 424 is being displayed, printing of the chart using the adjustment 2 can be started.

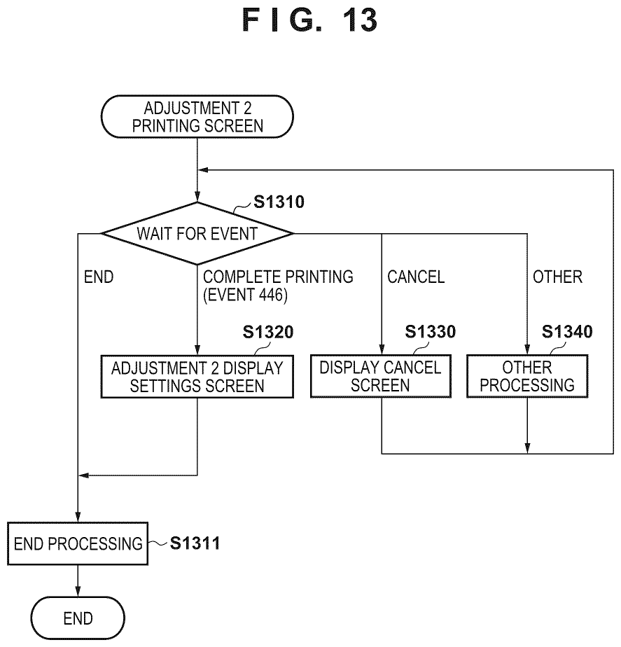

FIG. 13 is a flowchart for describing the display control processing of the adjustment 2 printing screen 425 by the image forming apparatus 201 according to the first embodiment. The processing illustrated by the flowchart is executed by the CPU 101 executing the program described above.

In step S1310, the CPU 101 waits for an event from the outside. Here, if the print complete event 446 is received, the processing proceeds to step S1320, and the CPU 101 displays the adjustment 2 settings screen 426 on the operation unit 106, and the processing proceeds to step S1311. Note that steps S1330, S1340, and S1311, which are processing executed when, in step S1310, there is a cancel instruction or when another event is received and when there is an end instruction, are the same as steps S1030, S1040, and S1011 of FIG. 10 and thus will not be described.

With this processing, when printing ends while the adjustment 2 printing screen 422 is being displayed, the adjustment 2 settings screen for setting the second adjustment parameter can be displayed on the operation unit.

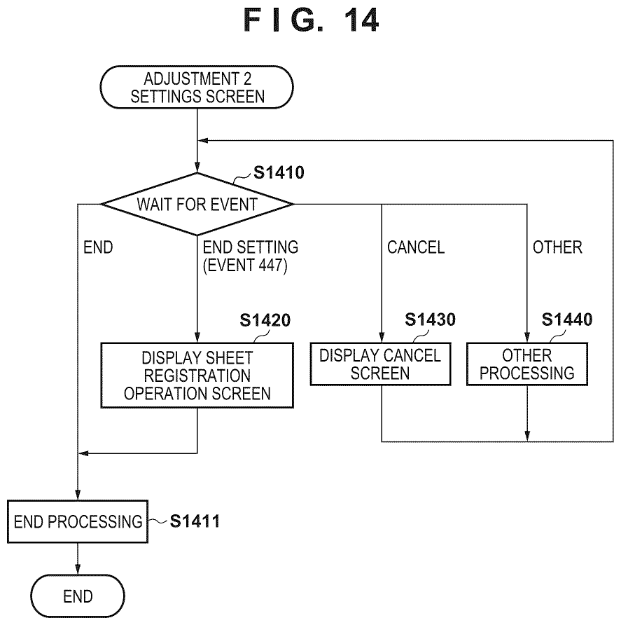

FIG. 14 is a flowchart for describing the display control processing of the adjustment 2 settings screen 426 by the image forming apparatus 201 according to the first embodiment. The processing illustrated by the flowchart is executed by the CPU 101 executing the program described above.

In step S1410, the CPU 101 waits for an event from the outside. Here, when the settings end instruction event 447 is received, the processing proceeds to step S1420, and the CPU 101 displays the sheet registration operation screen 427 on the operation unit 106, and the processing proceeds to step S1411. Note that steps S1430, S1440, and S1411, which are processing executed when, in step S1410, there is a cancel instruction or when another event is received and when there is an end instruction, are the same as steps S1130, S1140, and S1111 of FIG. 11 and thus will not be described.

With this processing, when setting ends while the adjustment 2 settings screen 426 is being displayed, the sheet registration operation screen for registering these can be displayed on the operation unit.

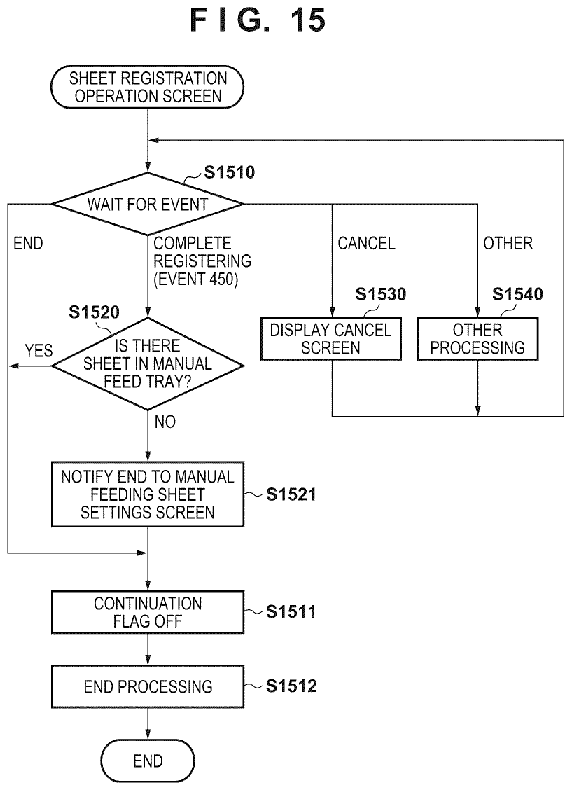

FIG. 15 is a flowchart for describing the display control processing of the sheet registration operation screen 427 by the image forming apparatus 201 according to the first embodiment. The processing illustrated by the flowchart is executed by the CPU 101 executing the program described above.

First, in step S1510, the CPU 101 waits for an event from the outside. Here, if the registration complete event 450 is received, the processing proceeds to step S1520, and the CPU 101 determines the presence/absence of sheets in the manual feed tray 121. If it is determined that there is a sheet in the manual feed tray 121, the processing proceeds to step S1511. If it is determined that there is an absence of sheets, the processing proceeds to step S1521. In step S1521, the CPU 101 notifies the manual feeding sheet settings screen 411 of the end, and the processing proceeds to step S1511. In step S1511, the CPU 101 turns off the continuation flag described above, and the processing proceeds to step S1512. In step S1512, the CPU 101 ends the sheet registration operation screen 427, and the processing ends. Also, in step S1510, if there is a cancel instruction, the processing proceeds to step S1530, a cancel screen is displayed, and the processing returns to step S1510. Also, in step S1510, if a different event is received, the processing proceeds to step S1540, and the CPU 101 executes processing in accordance with that event and the processing returns to step S1510.

With this processing, when sheet registration ends while the sheet registration operation screen is being displayed, the screen can transition to the manual feeding sheet settings screen if there is a sheet in the manual feed tray. On the other hand, if there is an absence of sheets in the manual feed tray, the manual feeding sheet settings screen is closed, and the screen can transition to the home screen.

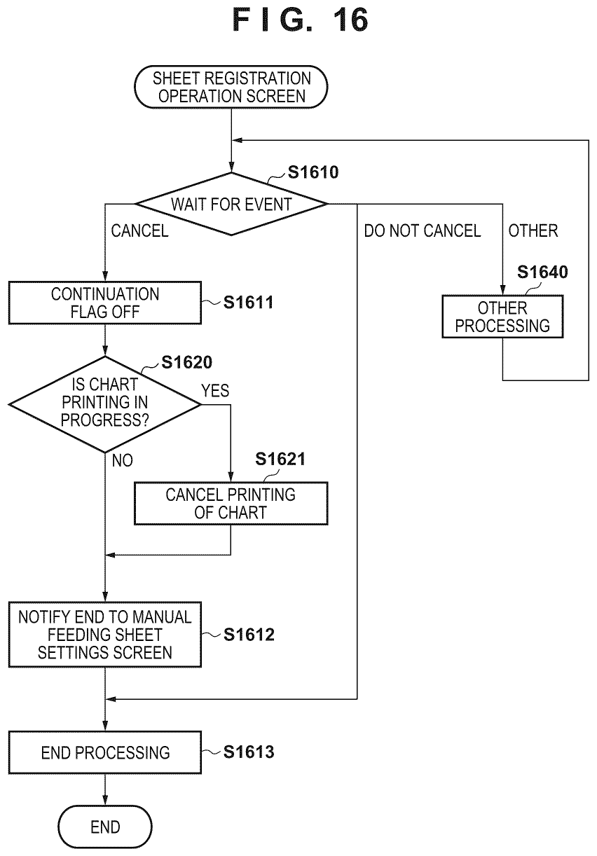

FIG. 16 is a flowchart for describing the display control processing of the cancel screen by the image forming apparatus 201 according to the first embodiment. The processing illustrated by the flowchart is executed by the CPU 101 executing the program described above. The processing is display processing for the plurality of screens described above, that is, cancel screens displayed when there is a cancel instruction on the sheet type registration start screen 412 to the sheet registration operation screen 427.

First, in step S1610, the CPU 101 waits for an event from the outside. Here, when a “cancel” instruction is issued on the screen being displayed at this point in time, the processing proceeds to step S1611, and the CPU 101 turns off the continuation flag of the RAM 102. Next, the processing proceeds to step S1620, and the CPU 101 determines whether or not the chart is being printed. If the chart is not being printed, the processing proceeds to step S1612. If the chart is being printed, the processing proceeds to step S1621, and the CPU 101 cancels the printing of the chart, and the processing proceeds to step S1612. In step S1612, the CPU 101 notifies the manual feeding sheet settings screen 411 of the end, and the processing proceeds to step S1613. Also, when a “don't cancel” instruction is issued on the screen being displayed at the point in time when waiting for an event in step S1610, the processing proceeds to step S1613. Also, in step S1610, if a different event is received, the processing proceeds to step S1640, and the CPU 101 executes processing in accordance with the received event and the processing returns to step S1610. In step S1613, the screen being displayed at this point in time is ended, and the processing ends.

As described above, according to the first embodiment, when a sheet is set in the manual feed tray, the screen transitions to the manual feeding sheet registration screen, and the manual feeding sheet type can be registered as a sheet type. Also, the screen can also transition to a screen for printing a chart for setting a parameter according to the manual feeding sheet type.

### Second Embodiment

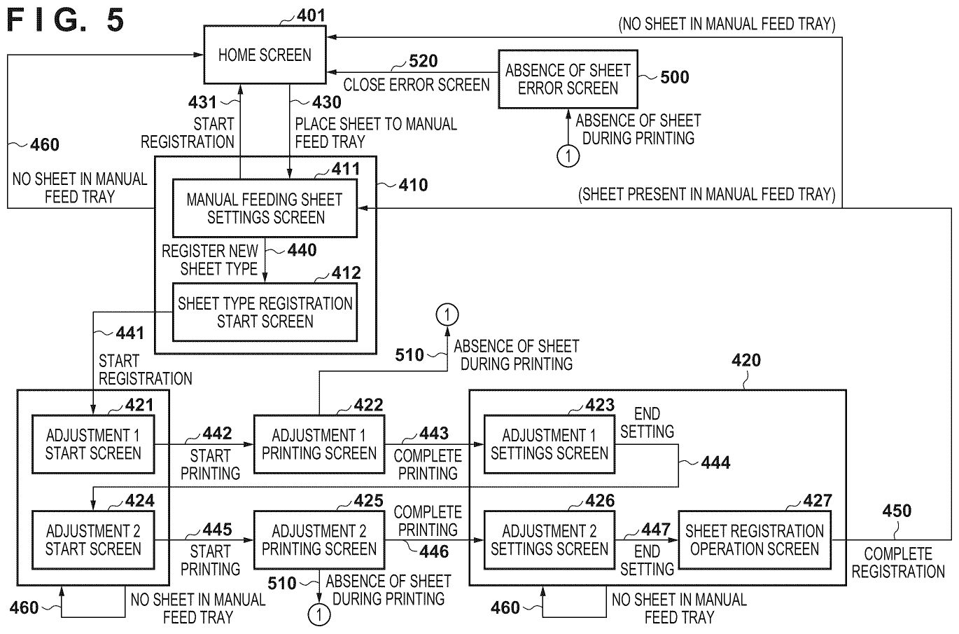

Next, the second embodiment of the present invention will be described with reference to FIGS. 5 and 17 to 19. Note that the hardware configuration and system configuration of the image forming apparatus according to the second embodiment is similar to that of the first embodiment described above, and thus description thereof will be omitted.

FIG. 5 is a diagram for describing the transitions of screens displayed on the operation unit 106 of the image forming apparatus 201 according to the second embodiment. In the example described below, these screens are operated via an operation unit 310. Only the sections that are different from FIG. 4 described above will be described below. The phase 420 of FIG. 5 includes the adjustment 1 start screen 421, the adjustment 1 settings screen 423, the adjustment 2 start screen 424, the adjustment 2 settings screen 426, and the sheet registration operation screen 427. When an absence of sheets during printing (event 510) is received on the adjustment 1 printing screen 422 and the adjustment 2 printing screen 425, which are screens indicating printing is being performed, an absence of sheet error screen 500 is displayed. Then, when the absence of sheet error screen 500 is closed via an instruction from the operation unit 106 (event 520), the new sheet type registration processing started at the event 440 is cancelled. The manual sheet feeding settings screen 411 also ends, and the screen transitions to the home screen 401.

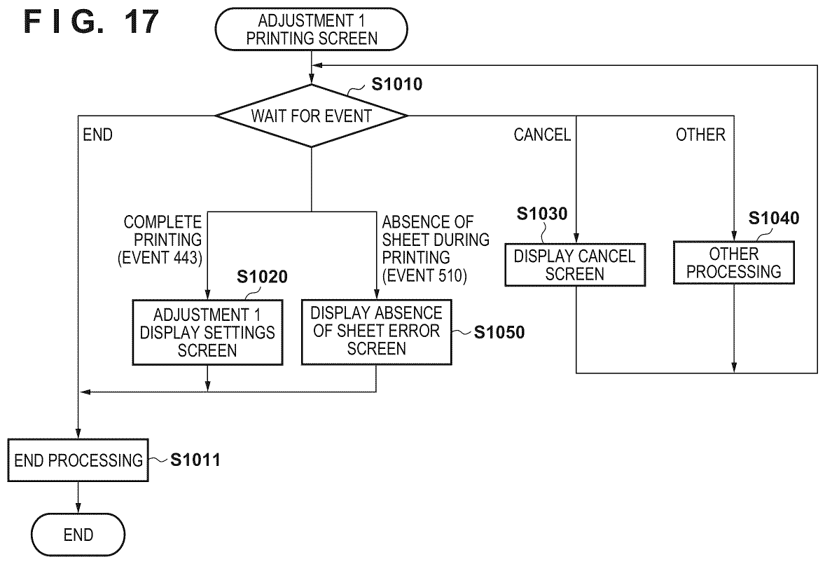

FIG. 17 is a flowchart for describing the display control processing of the adjustment 1 printing screen 422 by the image forming apparatus 201 according to the second embodiment. The processing illustrated by the flowchart is executed by the CPU 101 executing the program described above. Note that in FIG. 17, the same processing that is in the flowchart of FIG. 10 according to the first embodiment described above is given the same reference number, and the description thereof is omitted.

In step S1010, when a notification of an absence of sheets during printing is received (event 510), the processing proceeds to step S1050, the CPU 101 displays the absence of sheet error screen 500 on the operation unit 106, and the processing proceeds to step S1011.

With this processing, when an absence of sheets occurs while the adjustment 1 printing screen 422 is being displayed, the absence of sheet error screen 500 can be displayed on the operation unit 106.

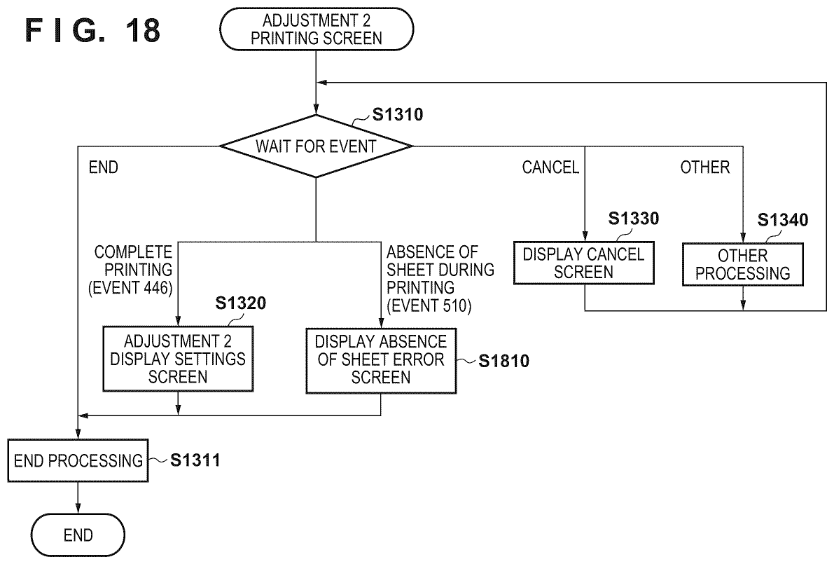

FIG. 18 is a flowchart for describing the display control processing of the adjustment 2 printing screen 425 by the image forming apparatus 201 according to the second embodiment. The processing illustrated by the flowchart is executed by the CPU 101 executing the program described above. Note that in FIG. 18, the same processing that is in the flowchart of FIG. 13 according to the first embodiment described above is given the same reference number, and the description thereof is omitted.

In step S1310, when a notification of an absence of sheets during printing is received (event 510), the processing proceeds to step S1810, the CPU 101 displays the absence of sheet error screen 500 on the operation unit 106, and the processing proceeds to step S1310.

With this processing, when an absence of sheets occurs while the adjustment 2 printing screen is being displayed, the absence of sheet error screen can be displayed on the operation unit.

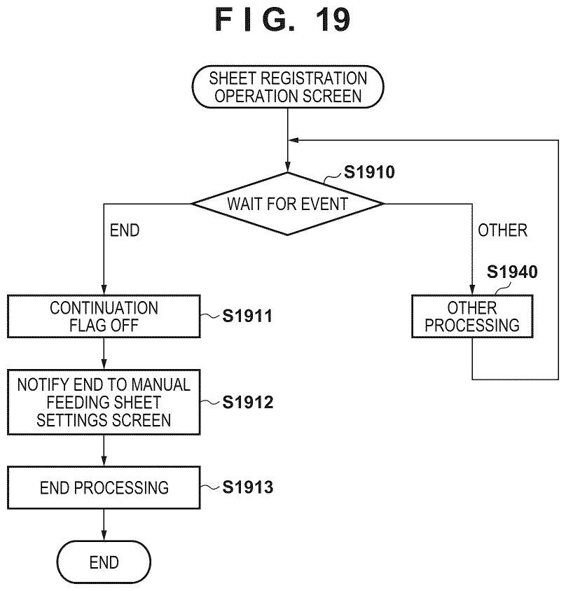

FIG. 19 is a flowchart for describing the display control processing of the absence of sheet error screen 500 by the image forming apparatus 201 according to the second embodiment. The processing illustrated by the flowchart is executed by the CPU 101 executing the program described above.

In step S1910, the CPU 101 waits for an event from the outside. Here, when an “end” instruction is received (event 520) on the screen being displayed at this point in time, the processing proceeds to step S1911, and the CPU 101 turns off the continuation flag. Then, the processing proceeds to step S1912, the CPU 101 ends the manual feeding sheet settings screen 411, and the processing proceeds to step S1913. Also, if a different event is received while waiting for an event in step S1910, the processing proceeds to step S1940, and the CPU 101 executes processing in accordance with the received event and the processing returns to step S1910. In step S1913, the CPU 101 ends the screen being displayed at this point in time, and the processing ends.

According to the second embodiment described above, when the absence of sheets is detected during printing of the chart for obtaining a parameter for adjustment, the absence of sheet error screen can be displayed, and the new sheet type registration processing can be cancelled.

Note that the processing according to the embodiments described above is processing in the case of the sheet to be registered being fed from the manual feed tray causing an absence of sheets in the manual feed tray. However, the same can be applied to a case in which a normally used feed cassette is used instead of a manual feed tray.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-142380, filed Sep. 1, 2023 which are hereby incorporated by reference herein in their entirety.

What is claimed is:

1. An image forming apparatus comprising:
one or more memory devices that store a set of instructions; and
one or more processors that execute the set of instructions to:
detect a characteristic of a sheet fed from a sheet feeding unit,
print a chart for detecting a parameter of the characteristic of the sheet on the sheet and register the parameter of the characteristic of the sheet on a basis of the chart together with the characteristic of the sheet, and
perform control to continue the registering in a case where an absence of sheets is detected at the sheet feeding unit in the registering.

2. The image forming apparatus according to claim 1,
wherein the memory stores whether or not the registering is being performed, and
the controlling includes performing control to continue the registering in a case where the memory stores that the registering is being performed when an absence of sheets is detected at the sheet feeding unit.

3. The image forming apparatus according to claim 2,
wherein the controlling includes performing control to end the registering in a case where the memory does not store that the registering is being performed when an absence of sheets is detected at the sheet feeding unit.

4. The image forming apparatus according to claim 1,
further comprising a display,
wherein the registering includes displaying a sheet settings screen on the display when a sheet is detected being set in the sheet feeding unit and starting the registering when an instruction to register a new sheet type is issued on the sheet settings screen.

5. The image forming apparatus according to claim 1,
further comprising a display,
wherein the registering includes displaying a screen indicating that printing is being performed on the display when the chart is printed.

6. The image forming apparatus according to claim 1,
further comprising a display,
wherein the registering includes displaying a settings screen for setting the parameter of the characteristic of the sheet on a basis of the chart on the display when printing of the chart is complete.

7. The image forming apparatus according to claim 5,
wherein the registering includes displaying an error screen indicating an absence of sheets on the display in a case where an absence of sheets is detected at the sheet feeding unit while the screen indicating that printing is being performed is being displayed.

8. The image forming apparatus according to claim 1,
wherein the characteristic of the sheet includes a type and grammage of the sheet.

9. The image forming apparatus according to claim 1,
wherein the sheet feeding unit is a manual feed tray.

10. A method for controlling an image forming apparatus comprising:
detecting a characteristic of a sheet fed from a sheet feeding unit;
printing a chart for detecting a parameter of the characteristic of the sheet on the sheet and registering the parameter of the characteristic of the sheet on a basis of the chart together with the characteristic of the sheet; and
performing control to continue the registering in a case where an absence of sheets is detected at the sheet feeding unit in the registering.

11. A non-transitory computer-readable storage medium comprising instructions that, when executed by a computer system, cause the computer system to:
detect a characteristic of a sheet fed from a sheet feeding unit;
print a chart for detecting a parameter of the characteristic of the sheet on the sheet and register the parameter of the characteristic of the sheet on a basis of the chart together with the characteristic of the sheet; and
perform control to continue the registering in a case where an absence of sheets is detected at the sheet feeding unit in the registering.
